(19) United States
(12) Patent Application Publication
(10) Pub. No.: US 2018/0290535 A1
(43) Pub. Date: Oct. 11, 2018

(54) ADJUSTABLE AIRFLOW ASSEMBLY AND A VEHICLE

(71) Applicant: GM GLOBAL TECHNOLOGY OPERATIONS LLC, Detroit, MI (US)

(72) Inventors: Ethan A. McMillan, Oak Park, MI (US); Rebecca Diane Tjoelker, Commerce Charter Twp., MI (US)

(73) Assignee: GM GLOBAL TECHNOLOGY OPERATIONS LLC, Detroit, MI (US)

(21) Appl. No.: 15/481,871

(22) Filed: Apr. 7, 2017

(51) Int. Cl. B60K 11/08; B62D 35/00

(52) U.S. Cl. CPC B60K 11/085; B62D 35/02; B62D 35/00; B62D 35/005

(57) ABSTRACT

An adjustable airflow assembly and a vehicle include a body. The assembly includes a brake apparatus and a flap attached to a second panel portion proximal to an opening. The flap is disposed between the brake apparatus and a first panel portion. The flap is movable between a first position and a second position. The flap at least partially uncovers the opening when in the first position to direct a flow of air through the opening toward the brake apparatus to cool the brake apparatus. The flap is disposed generally flat relative to an outer surface of the second panel portion when in the second position such that the flap covers the opening to direct the flow of air away from the opening to improve aerodynamics around the body as compared to the flap being in the first position.

### INTRODUCTION

Many vehicles include brakes to slow or stop the vehicle. Some of the vehicles have been designed with an opening along a front bumper to allow air to pass through the front bumper which is guided toward the brakes to cool the brakes. Other vehicles have been designed with an opening under the vehicle to guide air toward the brakes to cool the brakes.

### SUMMARY

The present disclosure provides an adjustable airflow assembly that includes a body having a first panel portion and a second panel portion disposed transverse to the first panel portion. The second panel portion includes an outer surface and an inner surface opposing the outer surface. The second panel portion defines an opening. The assembly also includes a brake apparatus disposed behind the first panel portion. Additionally, the assembly includes a flap attached to the second panel portion proximal to the opening. The flap is disposed between the brake apparatus and the first panel portion. The flap is movable between a first position and a second position. The flap at least partially uncovers the opening when in the first position to direct a flow of air through the opening toward the brake apparatus to cool the brake apparatus. The flap is disposed generally flat relative to the outer surface of the second panel portion when in the second position such that the flap covers the opening to direct the flow of air away from the opening to improve aerodynamics around the body as compared to the flap being in the first position.

The present disclosure also provides a vehicle that includes a body. The body includes a bumper fascia and a belly pan disposed transverse to the bumper fascia. The belly pan has an outer surface and an inner surface opposing the outer surface. The belly pan defines an opening. The vehicle also includes a brake apparatus disposed behind the bumper fascia. The vehicle further includes a flap attached to the belly pan proximal to the opening. The flap is movable between a first position and a second position. The flap at least partially uncovers the opening when in the first position to direct a flow of air through the opening toward the brake apparatus to cool the brake apparatus. The flap is disposed generally flat relative to the outer surface of the belly pan when in the second position such that the flap covers the opening to direct the flow of air away from the opening to improve aerodynamics around the body as compared to the flap being in the first position.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective view of a vehicle.

FIG. 2 is a schematic illustration of a pair of flaps in relation to a pair of brake apparatuses.

FIG. 3 is a schematic illustration of an actuator including an arm in different positions to move the flap to one of a first position, a second position and a third position.

FIG. 4 is a schematic fragmentary perspective view of the flap in the first position.

FIG. 5 is a schematic fragmentary perspective view of the flap in the second position.

FIG. 6 is a schematic fragmentary perspective view of the flap in the third position.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

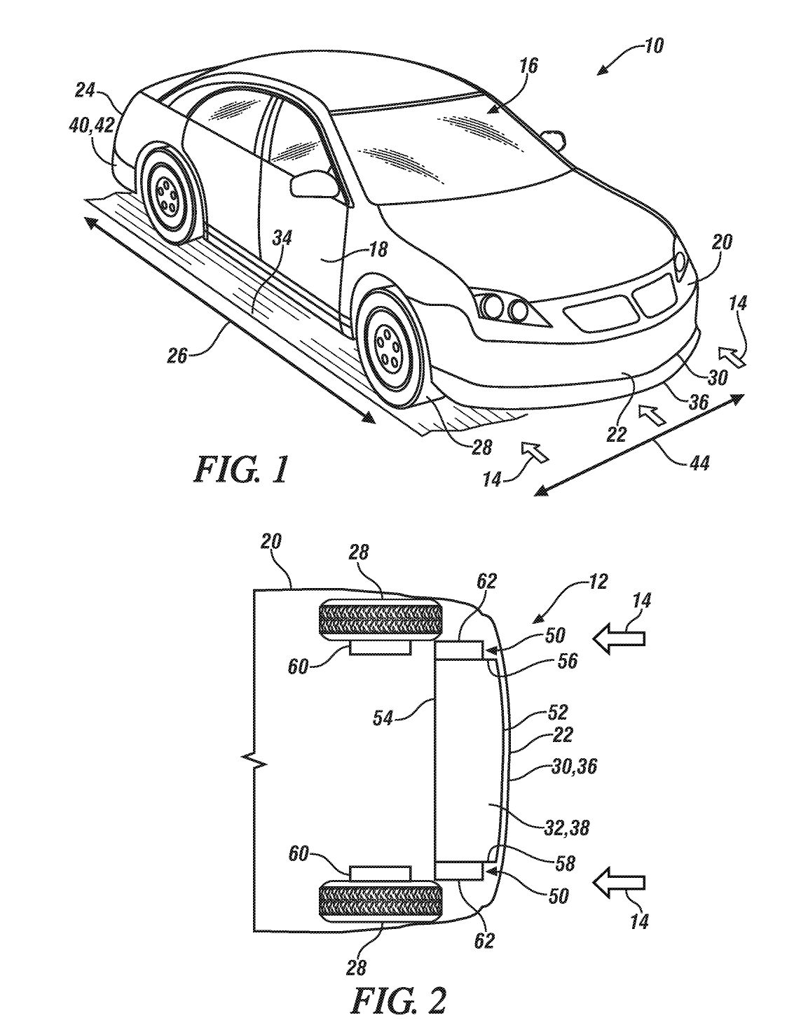

Referring to the FIGS., wherein like numerals indicate like or corresponding parts throughout the several views, a vehicle 10 is generally shown in FIG. 1 and an adjustable airflow assembly 12 is generally shown in FIG. 2. Generally, the adjustable airflow assembly 12 can direct a flow of air 14 (see arrow 14 in the FIGS.) in a particular manner to cool various component(s) and/or to improve aerodynamics which will be discussed in detail further below.

The adjustable airflow assembly 12 can be utilized in a vehicle application or a non-vehicle application. Non-limiting examples of the vehicles 10 can include cars, trucks, boats, watercrafts, off-road vehicles, aircrafts, farm equipment or any other suitable movable platform. Additionally, the vehicle 10 can include autonomously driven vehicles or vehicles driven via a human. Non-limiting examples of the non-vehicles can include machines, farm equipment or any other suitable non-vehicle.

For the vehicle application, the vehicle 10 can include a passenger compartment 16 (see FIG. 1). Generally, one or more occupants can be disposed in the passenger compartment 16. Furthermore, for a vehicle 10 driven by the human, one of the occupants can steer the vehicle 10 from the passenger compartment 16. The passenger compartment 16 can have one or more doors 18 that open and close to allow the occupants to enter and exit the vehicle 10.

Continuing with FIG. 1, the vehicle 10 can include a body 20 having a front end 22 and a rear end 24. The body 20 can include a plurality of fascia pieces or panels, some or all of which are visible from the outside of the vehicle 10. The front and rear ends 22, 24 are spaced from each other along a length 26 of the vehicle 10. Generally, the fascia pieces or panels surround the vehicle 10. The vehicle 10 can also include one or more wheels 28, and therefore, depending on the number of wheels 28 that the vehicle 10 utilizes, one or more of the fascia pieces can be configured to allow the wheel 28 to be disposed under part of the vehicle 10.

Again continuing with FIG. 1, the body 20 also includes a bumper fascia 30 and a belly pan 32 disposed transverse to the bumper fascia 30. The bumper fascia 30 can be disposed along the front end 22 of the vehicle 10 and the belly pan 32 can be disposed under the vehicle 10. Therefore, the belly pan 32 can face the ground 34. Generally, various components of the vehicle 10 are concealed behind one or more of the fascia pieces and the belly pan 32. It is to be appreciated that the bumper fascia 30 can be one of the fascia pieces or panels.

As best shown in FIG. 2, the adjustable airflow assembly 12 also includes the body 20. The body 20 includes a first panel portion 36 and a second panel portion 38 disposed transverse to the first panel portion 36. In certain embodiments, the first panel portion 36 can include the bumper fascia 30 and the second panel portion 38 can include the belly pan 32. The body 20 can also include a third panel portion 40 (shown in FIG. 1) spaced from the first and second panel portions 36, 38. The third panel portion 40 can include a rear bumper fascia 42. It is to be appreciated that the rear bumper fascia 42 can be one of the fascia pieces or panels.

Referring to FIG. 1, the fascia pieces or panels can include one or more of a first side panel which can include a rear quarter panel fascia and a second side panel which can include a front quarter panel fascia. FIG. 1 best illustrates one side of the vehicle 10, and it is to be appreciated that the other side of the vehicle 10 can be a mirror image of the illustrated side. The sides of the vehicle 10 are spaced from each other in a cross-car direction 44. The cross-car direction 44 is transverse or perpendicular to the length 26 of the vehicle 10. In other words, the rear and front quarter panel fascias along one side of the vehicle 10 are spaced in the cross-car direction 44 from the rear and front quarter panel fascias along the other side of the vehicle 10.

As best shown in FIG. 1, the bumper fascia 30 can be disposed along the front end 22 of the vehicle 10 and the rear bumper fascia 42 can be disposed along the rear end 24 of the vehicle 10. In certain embodiments, the bumper fascia 30 can be referred to as a front bumper. As mentioned above, the first panel portion 36 can include the bumper fascia 30. The rear and front quarter panel fascias can be disposed transverse to the bumper fascia 30.

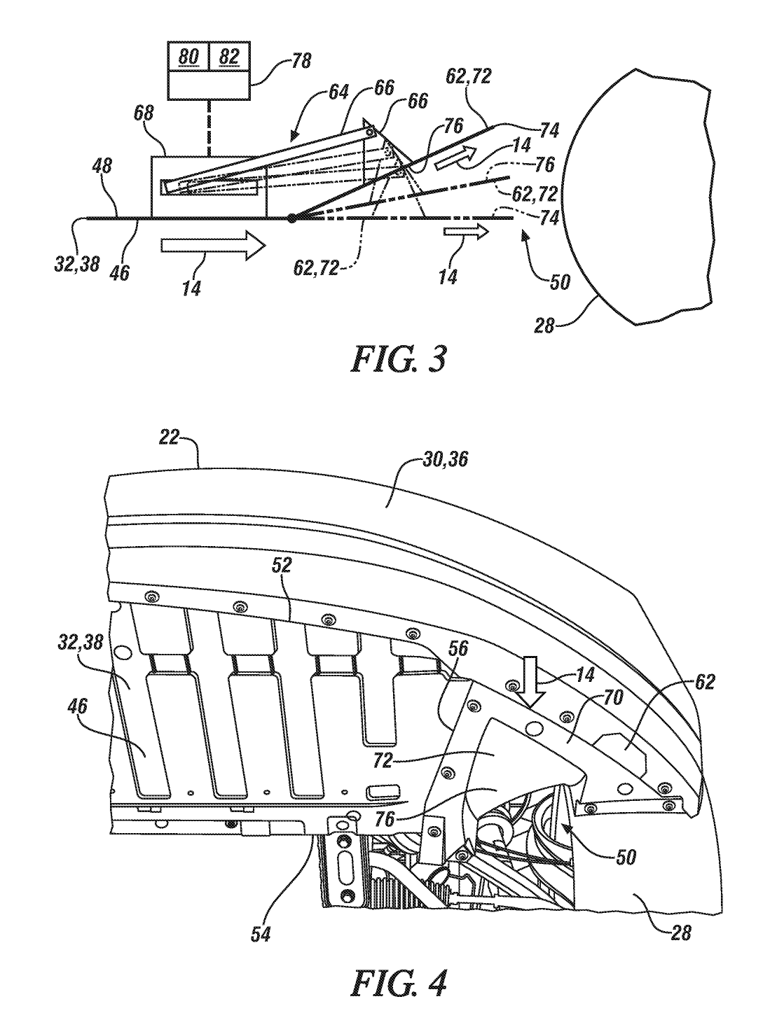

Referring to FIG. 3, the second panel portion 38 includes an outer surface 46 and an inner surface 48 opposing the outer surface 46. In certain embodiments, the belly pan 32 has the outer surface 46 and the inner surface 48 opposes the outer surface 46. Generally, the outer surface 46 faces the ground 34, and the inner surface 48 faces in the opposite direction from the ground 34.

Referring to FIGS. 3 and 4, the second panel portion 38 defines an opening 50. In certain embodiments, the belly pan 32 defines the opening 50. The second panel portion 38 can be any suitable configuration, and non-limiting examples are shown in the FIGS. Therefore, it is to be appreciated that the opening 50 can be any suitable location along the second panel portion 38. As such, the second panel portion 38 can surround all or part of the opening 50, or alternatively, the second panel portion 38 does not surround the opening 50, i.e., the opening 50 can be disposed along an edge of the second panel portion 38.

Furthermore, in certain embodiments, the opening 50 can be defined as a plurality of openings 50. Therefore, one of the openings 50 can be disposed proximal to one of the wheels 28 and another one of the openings 50 can be disposed proximal to another one of the wheels 28.

Turning to FIG. 2, the second panel portion 38 can include a first end 52 and a second end 54 spaced from each other. The first and second ends 52, 54 can be spaced from each other along the length 26 of the vehicle 10. Furthermore, the first end 52 can be disposed closer to the first panel portion 36 than the second end 54. Therefore, in certain embodiments, the belly pan 32 can include the first end 52 and the second end 54 spaced from each other, with the first end 52 disposed closer to the bumper fascia 30 than the second end 54.

Additionally, the second panel portion 38 can include a first edge 56 (see FIG. 2) disposed between the first and second ends 52, 54. In certain embodiments, the belly pan 32 can include the first edge 56 disposed between the first and second ends 52, 54. As shown in FIG. 2, for illustrative purposes only, the opening 50 can be disposed proximal to the first edge 56.

The second panel portion 38 can also include a second edge 58 (see FIG. 2) spaced from the first edge 56 and disposed between the first and second ends 52, 54. The first and second edges 56, 58 can be spaced from each other along the cross-car direction 44. In certain embodiments, the belly pan 32 can include the second edge 58 disposed between the first and second ends 52, 54. Therefore, if the second panel portion 38 defines a plurality of openings 50, one of the openings 50 can be disposed proximal to the first edge 56 and another one of the openings 50 can be disposed proximal to the second edge 58. As shown in FIG. 2, for illustrative purposes only, the openings 50 are illustrated proximal to respective edges 56, 58.

As best shown in FIG. 2, the adjustable airflow assembly 12 includes a brake apparatus 60 disposed behind the first panel portion 36. The brake apparatus 60 being behind the first panel portion 36 can be relative to the direction of the flow of air 14. In certain embodiments, the brake apparatus 60 is coupled to the wheel 28 and configured to brake the wheel 28, i.e., slow or stop rotation of the wheel 28. Therefore, the brake apparatus 60 is configured to slow or stop movement of the movable platform. The brake apparatus 60 can include one or more of a rotor, a brake pad, a brake drum, a brake shoe, a caliper, any other component(s) to slow or stop movement of the movable platform, etc.

In certain embodiments, the brake apparatus 60 can be defined as a plurality of brake apparatuses 60. Therefore, in this embodiment, one of the brake apparatuses 60 can be coupled to one of the wheels 28 and another one of the brake apparatuses 60 can be coupled to another one of the wheels 28. Again, the brake apparatuses 60 are configured to slow or stop movement of the movable platform.

In certain embodiments, the vehicle 10 includes the brake apparatus 60, which is disposed behind the bumper fascia 30. The brake apparatus 60 being behind the bumper fascia 30 can be relative to the direction of the flow of air 14 or relative to the front end 22 of the vehicle 10. Furthermore, the wheel 28 can be disposed behind the bumper fascia 30. The wheel 28 being behind the bumper fascia 30 can be relative to the direction of the flow of air 14 or relative to the front end 22 of the vehicle 10. As such, the brake apparatuses 60 and the wheels 28 are disposed between the front and rear bumper fascias 30, 42. If utilizing a plurality of brake apparatuses 60, the brake apparatuses 60 can be disposed behind the first panel portion 36/the bumper fascia 30.

Referring to FIGS. 3-6, the adjustable airflow assembly 12 includes a flap 62 attached to the second panel portion 38 proximal to the opening 50. The flap 62 can be utilized to change a direction of the flow of air 14. For example, when the movable platform is moving in a forward direction, the flow of air 14 is in the direction as illustrated in the FIGS. Therefore, generally, the flap 62 is movable to direct the flow of air 14 toward the brake apparatus 60 to cool the brake apparatus 60 and/or to direct the flow of air 14 along the outside of the body 20 to improve aerodynamics.

In certain embodiments, the flap 62 is attached to the first edge 56. In certain embodiments, the flap 62 is attached to the belly pan 32 proximal to the opening 50. Therefore, the flap 62 is disposed under the vehicle 10. As such, the flap 62 is not visible from the front end 22 of the vehicle 10. Furthermore, the flap 62 is not visible from the rear end 24 of the vehicle 10.

If utilizing a plurality of brake apparatuses 60, the flap 62 can be defined as a plurality of flaps 62. Therefore, one of the flaps 62 can be attached to the second panel portion 38 proximal to one of the openings 50 and another one of the flaps 62 can be attached to the second panel portion 38 proximal to another one of the openings 50. In certain embodiments, one of the flaps 62 can be attached to the first edge 56 of the second panel portion 38 and another one of the flaps 62 can be attached to the second edge 58 of the second panel portion 38. Therefore, the flap 62 illustrated in FIGS. 3-6 can be mirrored for the other side of the body 20. The below discussion primarily focuses on one flap 62, but it is to be appreciated that this discussion also applies to a plurality of flaps 62.

Referring to FIG. 2, generally, the flap 62 is disposed between the brake apparatus 60 and the first panel portion 36. Therefore, the flap 62 can be disposed behind the bumper fascia 30 and proximal to the wheel 28. The flap 62 being behind the bumper fascia 30 can be relative to the direction of the flow of air 14 or relative to the front end 22 of the vehicle 10. In certain embodiments, the flap 62 is disposed between the brake apparatus 60 and the bumper fascia 30. The flap 62 can be in any suitable location relative to the brake apparatus 60 to direct the flow of air 14 toward the brake apparatus 60 when it is desired to cool the brake apparatus 60.

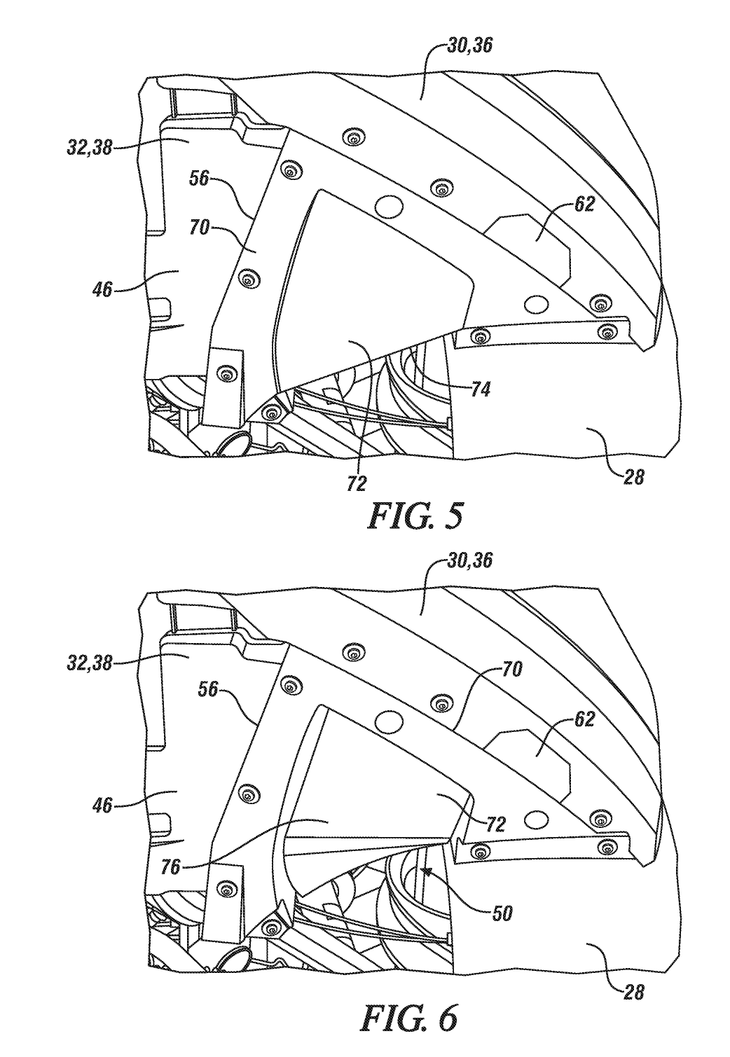

Referring to FIGS. 3-5, the flap 62 is movable between a first position and a second position. In certain embodiments, the flap 62 is also movable to a third position (see FIGS. 3 and 6). The third position is between the first and second positions. The first position is shown in FIG. 4, the second position is shown in FIG. 5 and the third position is shown in FIG. 6. Additionally, for illustrative purposes only, the flap 62 is shown in the first position in solid lines in FIG. 3, and the flap 62 is shown in phantom lines in the second and third positions in FIG. 3.

Referring to FIG. 4, the flap 62 at least partially uncovers the opening 50 when in the first position to direct the flow of air 14 through the opening 50 toward the brake apparatus 60 to cool the brake apparatus 60. Therefore, when the flap 62 is in the first position, cooling of the brake apparatus 60 is optimized as compared to the second and third positions.

Referring to FIG. 5, the flap 62 is disposed generally flat relative to the outer surface 46 of the second panel portion 38/the belly pan 32 when in the second position such that the flap 62 covers the opening 50 to direct the flow of air 14 away from the opening 50 to improve aerodynamics around the body 20 as compared to the flap 62 being in the first position. Said differently, the flap 62 can be generally flush with the outer surface 46 of the second panel portion 38/the belly pan 32 when in the second position. As such, the opening 50 is closed when the flap 62 is in the second position to minimize the flow of air 14 from entering the opening 50. When in the second position, aerodynamics can be improved by reducing drag and lift of the body 20. As such, aerodynamics is optimized when the flap 62 is in the second position.

Furthermore, referring to FIG. 6, the flap 62 partially uncovers the opening 50 in the third position such that some of the flow of air 14 enters the opening 50 and some of the flow of air 14 is directed away from the opening 50. As such, the third position can partially cool the brake apparatus 60 and partially improve aerodynamics around the body 20 as compared to the flap 62 being in the first position.

Referring to FIG. 3, the adjustable airflow assembly 12 can also include an actuator 64 configured to move the flap 62 between the first and second positions. Furthermore, the actuator 64 can move the flap 62 to the third position. Therefore, the actuator 64 can move the flap 62 to the first, second and third positions. As such, the actuator 64 can cycle the flap 62 between the positions. It is to be appreciated that the actuator 64 can move the flap 62 to any suitable number of positions, and the three positions illustrated are non-limiting examples. In certain embodiments, the actuator 64 can be defined as a plurality of actuators 64, with one of the actuators 64 configured to move one of the flaps 62 and another one of the actuators 64 configured to move another one of the flaps 62.

Continuing with FIG. 3, the actuator 64 can include an arm 66 attached to the flap 62. The arm 66 can be attached to the flap 62 by any suitable methods, and non-limiting examples can include fasteners, adhesive, welding, clips, clamps, couplers, etc. Furthermore, the arm 66 can be attached to the flap 62 directly or indirectly. Additionally, the arm 66 can include one or more pieces, and the arm 66 can be any suitable configuration.

The actuator 64 can also include a motor 68 attached to the second panel portion 38/the belly pan 32. The motor 68 is operable to control the position of the arm 66 in order to move the flap 62 to the first and second positions, as well as the third position. The motor 68 can be attached to the second panel portion 38/the belly pan 32 by any suitable methods, and non-limiting examples can include fasteners, adhesive, welding, clips, clamps, couplers, etc. Furthermore, the motor 68 can be attached to the second panel portion 38/the belly pan 32 directly or indirectly.

Depending on the number of positions, the motor 68 can control the position of the arm 66 to move the flap 62 to the desired position. The actuator 64 can be any suitable location and configuration, and the FIGS. are non-limiting examples. In addition to or instead of the motor 68, the actuator 64 can include a solenoid, a spring-bias apparatus, etc., to move the flap 62 to the desired position. Furthermore, the actuator 64 can operate to move the arm 66 linearly and/or rotationally. As such, depending on the type of the actuator 64, the flap 62 can move linearly and/or rotationally to the desired position.

Turning to FIGS. 4-6, the flap 62 can include a periphery 70 directly attached to the second panel portion 38. In certain embodiments, the periphery 70 can be directly attached to the belly pan 32. The flap 62 can also include a flexible portion 72 disposed adjacent to the periphery 70. Generally, the flexible portion 72 can be movable between the first and second positions, as well as the third position. Specifically, the arm 66 can be attached (directly or indirectly) to the flexible portion 72 such that the flexible portion 72 is movable between the first and second positions, as well as the third position. Therefore, the flexible portion 72 is movable between the positions in response to movement of the arm 66. As such, depending on the type of the actuator 64, the flexible portion 72 can move linearly and/or rotationally to the desired position. The flexible portion 72 can retract to at least partially uncover the opening 50 to direct the flow of air 14 into the opening 50 and toward the brake apparatus 60.

As best shown in FIG. 5, the flexible portion 72 can include a distal edge 74 spaced from the periphery 70 and can be movable between the first and second positions, as well as the third position. The flexible portion 72 can cover the opening 50 when the flap 62 is in the second position. Therefore, the flexible portion 72, including the distal edge 74, can be disposed generally flat relative to the outer surface 46 of the second panel portion 38 to direct the flow of air 14 away from the opening 50 when in the second position.

When the flexible portion 72 is in the first position, the distal edge 74 is positioned through the opening 50 such that the flexible portion 72 creates a ramp 76 (see FIGS. 4 and 6) that the flow of air 14 moves across. Therefore, the slope of the ramp 76 increases as the ramp 76 extends toward the distal edge 74 when in the first position. As such, the flow of air 14 enters the opening 50 spaced from the periphery 70. Simply stated, the ramp 76 remains closed at the periphery 70 regardless of the position of the flap 62 to minimize the flow of air 14 from entering the opening 50 at the periphery 70.

Generally, the periphery 70 is formed of a first material and the flexible portion 72 is formed of a second material being more flexible than the first material. Non-limiting examples of the first material can include one or more polymers, metal, alloy, composite, etc., and/or combinations thereof. Non-limiting examples of the second material can include one or more polymers, fabric, etc., and/or combinations thereof.

Again, continuing with FIG. 3, the adjustable airflow assembly 12 can include a controller 78 configured to signal the actuator 64 to move the flap 62 to the first and second positions, as well as the third position. When utilizing a plurality of actuators 64, one controller 78 can control all of the actuators 64, or alternatively, a plurality of controllers 78 can be utilized, with one of the controllers 78 in communication with one of the actuators 64 and another one of the controllers 78 in communication with another one of the actuators 64. Also, if utilizing a plurality of controllers 78, each of the controllers 78 can be in communication with each other.

The controller 78 can include a processor 80 and a memory 82 on which is recorded instructions for communicating with the actuator(s) 64, controller(s) 78, etc. The controller 78 is configured to execute the instructions from the memory 82, via the processor 80. For example, the controller 78 can be a host machine or distributed system, e.g., a computer such as a digital computer or microcomputer, and/or as a proportional-integral-derivative (PID) controller device having the processor 80, and, as the memory 82, tangible, non-transitory computer-readable memory such as read-only memory (ROM) or flash memory. The controller 78 can also have random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 78 can include all software, hardware, memory 82, algorithms, connections, sensors, etc., necessary to communicate with the actuator(s) 64, controller(s) 78, etc. It is to be appreciated that the controller 78 can also include any device capable of analyzing data from various sensors, comparing data, making the necessary decisions required to communicate with the actuator(s) 64, controller(s) 78, etc.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An adjustable airflow assembly comprising:
a body having a first panel portion and a second panel portion disposed transverse to the first panel portion, with the second panel portion including an outer surface and an inner surface opposing the outer surface, and wherein the second panel portion defines an opening;
a brake apparatus disposed behind the first panel portion;
a flap attached to the second panel portion proximal to the opening and disposed between the brake apparatus and the first panel portion, with the flap movable between a first position and a second position; and
wherein the flap at least partially uncovers the opening when in the first position to direct a flow of air through the opening toward the brake apparatus to cool the brake apparatus, and the flap is disposed generally flat relative to the outer surface of the second panel portion when in the second position such that the flap covers the opening to direct the flow of air away from the opening to improve aerodynamics around the body as compared to the flap being in the first position.

2. The assembly as set forth in claim 1 further including an actuator configured to move the flap between the first and second positions.

3. The assembly as set forth in claim 2 wherein the actuator includes an arm attached to the flap and a motor attached to the second panel portion, with the motor operable to control a position of the arm in order to move the flap to the first and second positions.

4. The assembly as set forth in claim 3 wherein the flap includes a periphery directly attached to the second panel portion and a flexible portion disposed adjacent to the periphery, with the arm attached to the flexible portion such that the flexible portion is movable between the first and second positions.

5. The assembly as set forth in claim 2 further including a controller configured to signal the actuator to move the flap to the first and second positions.

6. The assembly as set forth in claim 1 wherein the second panel portion includes a first end and a second end spaced from each other, with the first end disposed closer to the first panel portion than the second end, and wherein the second panel portion includes a first edge disposed between the first and second ends, and wherein the opening is disposed proximal to the first edge.

7. The assembly as set forth in claim 6 wherein the flap is attached to the first edge.

8. The assembly as set forth in claim 1 wherein the flap includes a periphery directly attached to the second panel portion and a flexible portion disposed adjacent to the periphery, with the flexible portion movable between the first and second positions.

9. The assembly as set forth in claim 8 wherein the flexible portion includes a distal edge spaced from the periphery and movable between the first and second positions, with the flexible portion covering the opening when the flap is in the second position.

10. The assembly as set forth in claim 8 wherein the periphery is formed of a first material and the flexible portion is formed of a second material being more flexible than the first material.

11. The assembly as set forth in claim 1 wherein the first panel portion includes a bumper fascia.

12. The assembly as set forth in claim 1 wherein the second panel portion includes a belly pan.

13. The assembly as set forth in claim 1 wherein the flap is movable to a third position that is between the first and second positions, with the flap partially uncovering the opening in the third position such that some of the flow of air enters the opening and some of the flow of air is directed away from the opening.

14. The assembly as set forth in claim 1:
further including an actuator configured to move the flap between the first and second positions, with the actuator including an arm attached to the flap and a motor attached to the second panel portion, and with the motor operable to control a position of the arm in order to move the flap to the first and second positions;
further including a controller configured to signal the actuator to move the flap to the first and second positions;
wherein the second panel portion includes a first end and a second end spaced from each other, with the first end disposed closer to the first panel portion than the second end;
wherein the second panel portion includes a first edge disposed between the first and second ends;
wherein the opening is disposed proximal to the first edge;
wherein the flap includes a periphery directly attached to the second panel portion and a flexible portion disposed adjacent to the periphery, with the arm attached to the flexible portion such that the flexible portion is movable between the first and second positions in response to movement of the arm;
wherein the flexible portion covers the opening when the flap is in the second position; and
wherein the periphery is formed of a first material and the flexible portion is formed of a second material being more flexible than the first material.

15. A vehicle comprising:
a body including a bumper fascia and a belly pan disposed transverse to the bumper fascia, with the belly pan having an outer surface and an inner surface opposing the outer surface, and wherein the belly pan defines an opening;
a brake apparatus disposed behind the bumper fascia;
a flap attached to the belly pan proximal to the opening, with the flap movable between a first position and a second position; and
wherein the flap at least partially uncovers the opening when in the first position to direct a flow of air through the opening toward the brake apparatus to cool the brake apparatus, and the flap disposed generally flat relative to the outer surface of the belly pan when in the second position such that the flap covers the opening to direct the flow of air away from the opening to improve aerodynamics around the body as compared to the flap being in the first position.

16. The vehicle as set forth in claim 15 wherein the flap is disposed between the brake apparatus and the bumper fascia.

17. The vehicle as set forth in claim 15 further including a wheel disposed behind the bumper fascia, with the brake apparatus coupled to the wheel and configured to brake the wheel, and wherein the flap is disposed behind the bumper fascia and proximal to the wheel.

18. The vehicle as set forth in claim 15:
further including an actuator configured to move the flap between the first and second positions, with the actuator including an arm attached to the flap and a motor attached to the belly pan, and with the motor operable to control a position of the arm in order to move the flap to the first and second positions;
further including a controller configured to signal the actuator to move the flap to the first and second positions;
wherein the belly pan includes a first end and a second end spaced from each other, with the first end disposed closer to the bumper fascia than the second end;
wherein the belly pan includes a first edge disposed between the first and second ends;
wherein the opening is disposed proximal to the first edge;
wherein the flap includes a periphery directly attached to the belly pan and a flexible portion disposed adjacent to the periphery, with the arm attached to the flexible portion such that the flexible portion is movable between the first and second positions in response to movement of the arm;
wherein the flexible portion covers the opening when the flap is in the second position; and
wherein the periphery is formed of a first material and the flexible portion is formed of a second material being more flexible than the first material.
